(19) United States
(12) Patent Application Publication
(10) Pub. No.: US 2005/0091939 A1
(43) Pub. Date: May 5, 2005

(54) Door assembly for menu board

(76) Inventors: Brian J. Hillstrom, Rockford, MN (US); Gary D. Rigby, West Bloomfield, MI (US)

Correspondence Address: HARNESS, DICKEY & PIERCE, P.L.C., P.O. BOX 828, BLOOMFIELD HILLS, MI, 48303, US

(21) Appl. No.: 10/937,834

(22) Filed: Sep. 9, 2004

Related U.S. Application Data
(60) Provisional application No. 60/501,356, filed on Sep. 9, 2003.

(51) Int. Cl. E06B 3/70

(52) U.S. Cl. 52/455

(57) ABSTRACT

A door assembly for a sign display is disclosed which may be readily configured to support graphic indicia of various sizes and shapes. The door assembly includes a door frame having a pair of side rails and a pair of end rails which supports a translucent door panel. The door frame further supports a diffusion panel in spaced relationship from the door panel. A plurality of support channels are releasably retained between the side rails. The support channels are captured between the door panel and the diffusion panel to define a display cell within which the graphic indicia are supported.

### CROSS-REFERENCE TO RELATED APPLICATIONS

This application claims the benefit of U.S. Provisional Application No. 60/501,356, filed on Sep. 9, 2003. The disclosures of the above application is incorporated herein by reference.

### FIELD OF THE INVENTION

The present invention relates to a door assembly for an illuminated display sign of the type having a housing, interior lights, and a translucent panel for presentation of a backlit graphic indicia in the form of advertisement, point of purchase information and the like.

### BACKGROUND OF THE INVENTION

Illuminated outdoor signs and display devices are commonly used for presenting advertising and point of purchase information. For example, fast-food restaurants use signs on their premises adjacent pathways leading to the restaurant or along their vehicle drive-through service lanes. These devices are used to display various menu items and/or to provide information and prices for consumers. In addition, “specials” are often promoted by these devices. As such the size of the graphic indicia may vary considerably depending on the given application. These signs are often lighted for enhanced viewing, either in the front by spot light, flood lights or overhead lighting, or from the back through transparent panels.

The design of these signs must be readily adjustable to accommodate a wide variety and size of graphic indicia. To this end the viewable area is divided into sections by support members that are releasably fastened or otherwise secured to the sign. The support members capture the edge of the graphic indicia and hold it in place. While sign of this design adequately support most standard-sized graphics, larger graphics tend to bend or bow and thus slightly distorting the displayed image. Furthermore, the graphics used in conventional displays typically have a surface treatment, such as duratrans graphics, to enhance the diffusion of light therethrough. These variables can effect the overall quality of the displayed information.

When used outdoors, sign displays of this type must also be able to withstand environmental conditions, such as wind, rain, snow, sun, freezing temperatures and elevated temperatures, and still maintain their integrity and usefulness for their intended purposes. With enclosed housings and with transparent members covering and protecting the display indicia, condensation and moisture can adversely effect the display. Moisture which enters the device or is created by condensation is often difficult to remove and frequently adversely affects the aesthetics and visibility of the displays. Likewise, such enclosed, backlit signs experience relatively high internal temperature due to the heat generated by the lights as well as green house effect caused by the sun load on the display. Such extreme internal conditions can also significantly impair the viewability of the sign and the displayed information and even warp and destroy the display indicia.

Accordingly, there is a need in the art to provide an improved sign display which may be readily adapted to accommodate graphic indicia of various shapes and sizes, particularly larger sized graphic. The sign display should also be sufficient robust to withstand the adverse operating conditions of wind, precipitation and temperature extremes.

### SUMMARY OF THE INVENTION

The present invention is directed to a door assembly which may be readily configured to support graphic indicia of various sizes and shapes. The door assembly includes a door frame having a pair of side rails and a pair of end rails which supports a translucent door panel. The door frame further supports a diffusion panel in spaced relationship from the door panel. A plurality of support channels are releasably retained between the side rails. The support channels are captured between the door panel and the diffusion panel to define a closed cell within which the graphic indicia are supported. The support channels are readily positionable within the frame without the use of fasteners, clips or tools.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 depicts a door assembly for a menu board in accordance with the present invention;

FIG. 2A illustrates a cross-section of the door assembly taken through line II-II shown in FIG. 1;

FIG. 2B illustrates a cross-section of an alternate embodiment for the door assembly similar to that shown in FIG. 2A;

FIG. 3A is a cross-section through the door assembly taken at line III-III shown in FIG. 1;

FIG. 3B is of an alternate embodiment for the door assembly similar to that shown in FIG. 3A;

FIG. 4 is a cross-section taken through the door assembly at line IV-IV shown in FIG. 1;

FIG. 5 is a cross-section taken through the door assembly at line V-V shown in FIG. 1; and

FIG. 6 is a partial perspective view illustrating the interface between the support channels and the frame members of the door assembly illustrated in FIG. 1.

### DETAILED DESCRIPTION OF THE PREFERRED EMBODIMENT

The following description of the preferred embodiment is merely exemplary in nature and is in no way intended to limit the invention, its application, or uses.

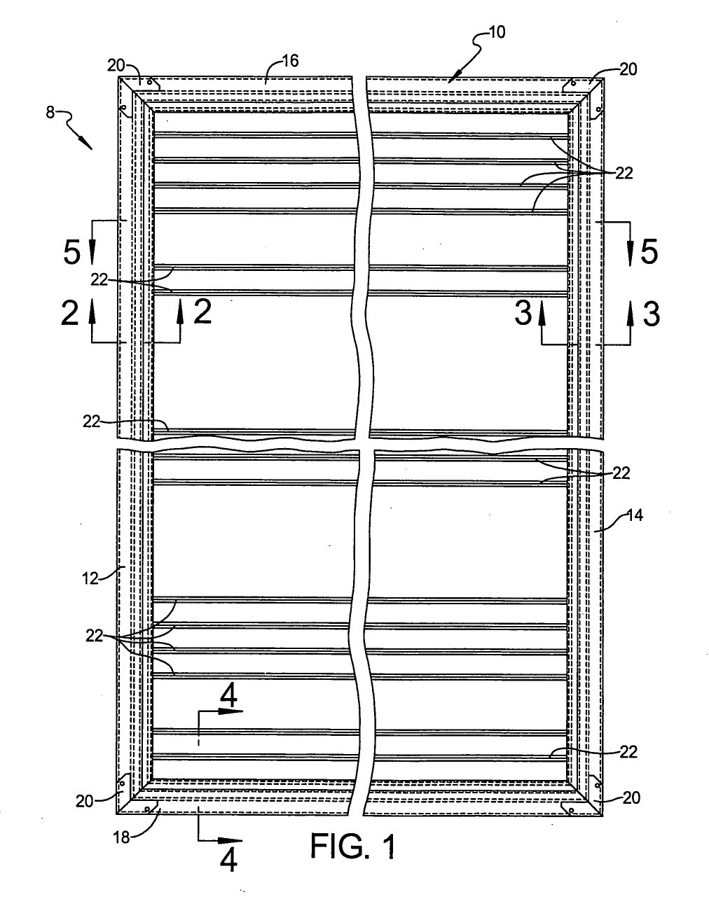

In accordance with a preferred embodiment of the present invention, a door assembly 8 is generally illustrated in FIG. 1. The door assembly 8 includes a door frame 10 having two side rails 12, 14 and two end rails 16, 18 secured together. Corner keys 20 are disposed at the ends of rails 12, 14, 16, 18 for securing the door assembly in the generally rectangular configuration. Door assembly 8, and in particular side rail 12, is adapted to be hingedly secured to a suitably sized enclosure (not shown) which houses a light source (not shown) for providing back lit illumination of the graphic indicia 24 supported within the door assembly 8. A plurality of support channels 22 extend between the side rails 12,14 and divide the door frame 10 into discrete areas or rows for supporting graphic indicia 24 within the door frame 10. The support channels 22 are selectively positionable within the door frame 10 as further described below to adjust or otherwise modify the shape and configuration of the display area. While the door frame 8 is generally illustrated in a rectangular configuration, one skilled in the art will readily recognize that the specific shape of the door frame 10 may be readily adapted according to the specification of a given application.

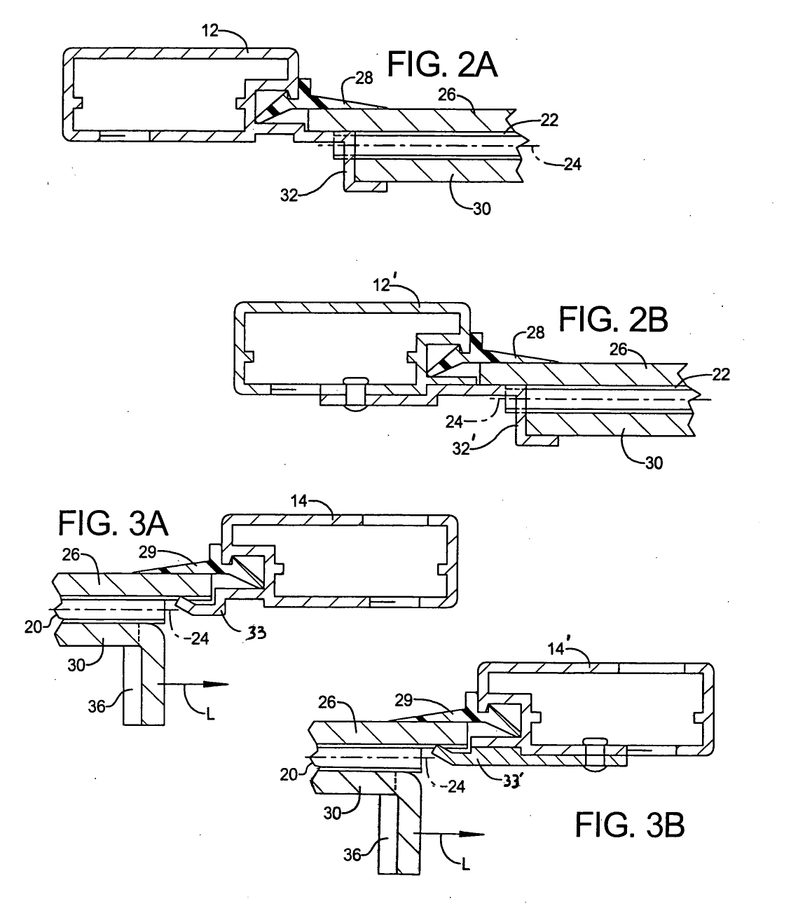

As best seen in FIGS. 2A, 3A and 4, the door assembly 8 further includes a translucent door panel 26 supported in door frame 10. Specifically, the inner surface of the door panel 26 is supported on inwardly extending flanges 32, 33 formed on rails 12, 14, 16, 18. A rubber seal or gasket 28 cooperates with the rails 12, 14, 16, 18 to secure the door panel 26 within the door frame 10. Furthermore, the gasket 28 provide a weather-tight seal along the interface between the outer surface of door panel 26 and the door frame 10. In the form shown, the rubber gasket 28 is an angled seal secured to the rail and having an outer edge in sealing engagement with the outer surface of the door panel and an inner edge disposed in a channel formed in the rail. However, one skilled in the art will recognize that the gasket 28 could be modified to provide a rubber channel that wraps around door panel 26 like a glazing channel to provide a tighter interface between the door panel 26 and the rails.

The door assembly 8 further includes a diffuser panel 30 slideably supported in the door frame 10. The door frame 10, and in particular the side support rail 12 and the end supports rails 16, 18, have a stepped flange 32 extending generally inwardly to support diffuser panel 30 therein. In contrast, the flange 33 on side rail 14 does not include a similar step thereby allowing the diffuser panel 30 to be slideably positioned into and out of door frame 10 in a lateral direction generally indicated by the arrow L shown in FIG. 3. To facilitate manipulation, diffuser panel 30 has an outwardly turned edge 34 which provides a grasping surface for slideably positioning the diffuser panel. A reinforcement bar 36 may be formed along flange 34 for providing additional stiffness to flange 34 of diffuser panel 30.

Referring now to FIGS. 2B and 3B, an alternate embodiment of the door assembly 8 is illustrated which includes side rails 12′, 14′. Side rail 12′ is substantially identical to side rail 12 with the exception that the stepped flange 32′ is formed by a separate extruded member that conforms with an inner surface of the rail 12′. The notches 38 may be formed in the stepped flange 32′. Likewise, side rail 14′ is substantially identical to side rail 14 with the exception that the flange 33′ is formed by a separate extruded member that conforms with an inner surface thereof. The notches 42 may be formed in the stepped flange 33′. Flanges 32′, 33′ are secured to rails 12′, 14′ by a fastener, for example by a rivet as shown, of some other suitable means such as adhesive, welding, brazing, staking, etc.

This alternate design enables the use of common parts for different door assembly configurations. For example, a door assembly 8 with side rails 12′, 14′ but without flanges 32′, 33′ could be employed. In this configuration, the door opening defines the graphic cell (i.e., the opening is not subdivided into smaller graphics cells) and the top and bottom rails 16, 18 receive a graphic indicia 24. By way of another example, a door assembly 8 with side rails 12′, 14′ having flanges 32′, 33′ which do not have notches formed therein could be employed. In this configuration, the door opening defines the graphic cell (i.e., the opening is not subdivided into smaller graphics cells) and the rails 12′, 14′, 16, 18 receive a graphic indicia 24.

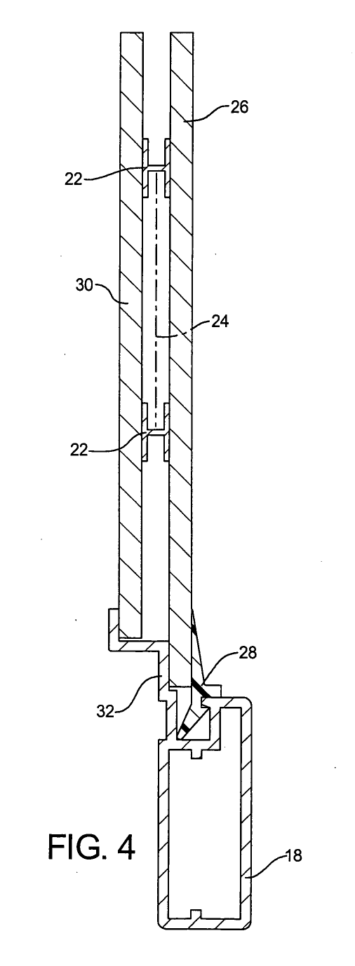

Referring again to FIGS. 2A, 3A and 4, channels 22 are enclosed between the door panel 26 and the diffuser panel 30 to provide a relatively thin interior volume within which the graphic indicia 24 are supported for display as best seen in FIG. 4. The door frame 10 and in particular the side rails 12, 14 are configured with a series of spaced notches 38, 42 which receive support channels 22. With particular reference to FIGS. 2 and 6, support rail 12 has a series of spaced notches 38 formed in the lateral flange 32. Notch 38 is sized to receive a free end 40 of support channel 22 therein. Similarly, side rail 14 has a plurality of spaced notches 42 formed in lateral flange 32 which is adapted to receive the opposite free end 44 of support channel 22. As best seen in FIG. 1, notches 38, 42 are formed along the length of rails 12, 14. As presently preferred these notches are equally spaced along the side rails 12, 14 to provide adjustability and adaptability for configuring the door assembly 8.

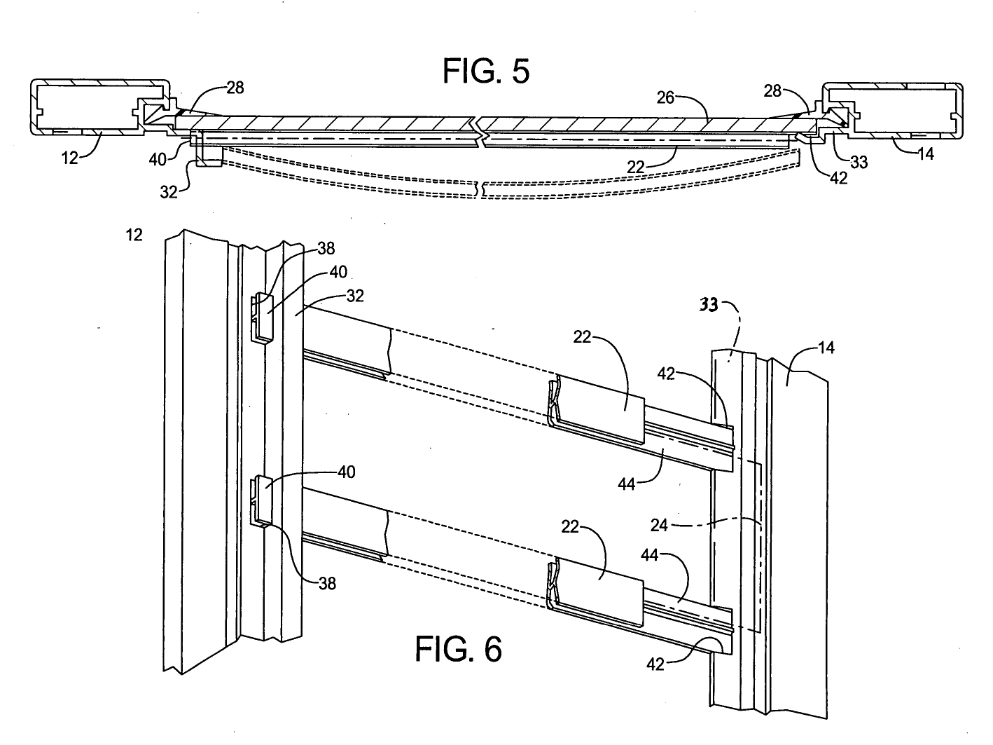

The support channel 22 may be selectively inserted into and removed from door frame 10 in the following manner. Free end 40 of support channel 22 is inserted into notch 38 formed in side rail 12. A flexing force is applied to the support channel 22 to bow outwardly away from door panel 26, thereby shortening the effective length of the support channel 22 until it may be inserted into the notch 42 formed in side rail 14. The support channel 22, in this bowed configuration, is illustrated in broken lines in FIG. 5. Once the opposite free end 44 is inserted into notch 42 of side rail 14, the support channel 22 has sufficient memory so as to be returned to its straightened configuration once the flexing force is removed. As a result, the free ends of support channel 22 are releasably secured between side rails 12, 14 without additional fasteners or retainer and without the use of special tools.

As presently preferred, the support channels 22 are formed having a generally H-shaped cross-section as best seen in FIG. 4. Furthermore, the free end 44 of the support channel 22 which cooperates with side rail 14 has a portion of the vertical leg removed for facilitating insertion of the support channel into the side rail 14, as well as for facilitating insertion of the graphic indicia within the door assembly 8. A portion of the graphic indicia 24 extend over flange 32 formed on rail 14 as best seen in FIGS. 3 and 6. In this manner, the graphics are easily accessible and may be readily changed without removing diffusion panel 30 from door frame 10.

As presently preferred, the frame members 12, 14, 16, 18 of the door assembly 8, as well as the support channels 22 are extruded components. In this regard, these components are suitably formed from an extrudible aluminum such as 6061-T6. This material has been found to provide sufficient strength and stiffness for the metal components of the door frame, while at the same time provide adequate flexibility to allow repeated positioning of the support channels 22.

The door assembly 8, and in particular the arrangement of the support channels 22 between door panel 26 and diffuser panel 30, define thin discrete display cells 48 which support the graphic indicia 24. In this manner, the graphic indicia 24 is supported on its front face by door panel 26, on its rear face by diffuser panel 30 and along the upper and lower edges by support channels 22. By providing a display cell which supports the indicia from the sides, as well as the front and the back, the present invention enables the use of much larger graphics than otherwise usable in conventional display signs. Furthermore, with the use of a separate diffuser panel 30, the present invention is readily adaptable to a wide variety of graphic indicia. Specifically, the graphic indicia do not have to be treated to provide the light diffusing function. Furthermore, the thin configuration of the display cell 48 diminishes the effect of sun load on the graphics, and further improves the visual appearance of the graphic indicia 24 by supporting it in a relatively planar fashion.

As noted above, the present invention is generally directed to a door frame assembly where a series of support channels are adjustably positionable between a pair of panel assemblies to define a graphics cell. The door assembly may be hingedly coupled to an enclosure in the form of a light box to provide a backlit display. While the present invention has been described with particular reference to the preferred embodiment described and illustrated above, one skilled in the art will readily recognize that various adaptations, modifications or changes may be made to the present invention.

The description of the invention is merely exemplary in nature and, thus, variations that do not depart from the gist of the invention are intended to be within the scope of the invention. Such variations are not to be regarded as a departure from the spirit and scope of the invention

1. A door assembly for a menu board comprising:
a door frame including a pair of side rails supported in a spaced relationship by a pair of end rails and defining a door opening, each of said pair of side rails having a plurality of notches formed therein;
a support channel having a first free end disposed in a first notch in one of said pair of side rails and a second free end disposed in a second notch formed in another of said pair of side rails such that said support channel is releasably retained between said pair of side rails;
a first panel supported on said door frame over said door opening;
a second panel supported on said door frame in spaced relationship to said first panel such that said support channel is captured between said first panel and said second panel to define a display cell for supporting a graphic indicia therein.

2. The door assembly of claim 1 wherein said each of said pair of side rails and each of said pair of end rails has a flange formed thereon to support said first panel.

3. The door assembly of claim 2 further comprising a seal secured to said door assembly and retaining said first panel thereto over said door opening.

4. The door assembly of claim 3 wherein said first panel is interposed between said seal and said flange.

5. The door assembly of claim 2 wherein said flange is separate from a respective rail and secured thereto.

6. The door assembly of claim 2 wherein said first notch is formed in said flange of said one of said pair of side rails and said second notched is formed in said another of said pair of side rails.

7. The door assembly of claim 1 wherein said first free end of said support channel extends past said flange through a first notch and said second free end extends through said second notch.

8. The door assembly of claim 7 wherein said support channel is a flexible support channel configured to bow for insertion into said first and second notches.

9. The door assembly of claim 1 wherein said support channel comprises a support channel having an H-shaped cross-section.

10. The door assembly of claim 2 wherein said second panel is slidably supported in said door assembly.

11. The door assembly of claim 10 wherein said flange associated with said pair of end rails comprises a stepped flange to support said second panel in said door assembly.

12. The door assembly of claim 11 wherein said flange associated with one of said pair of side rails comprises a stepped flange to support said second panel in said door assembly.

13. The door assembly of claim 1 further comprising a plurality of support channel, each of said plurality of support channels having a first free end disposed in a notch in one of said pair of side rails and a second free end disposed in a notch formed in another of said pair of side rails such that said plurality of support channels are releasably retained between said pair of side rails in a parallel arrangement to define a set of display cells for supporting graphic indicia therein.

14. The door assembly of claim 1 wherein said first panel comprises a translucent panel.

15. The door assembly of claim 1 wherein said second panel comprises a light-diffusing panel.

16. The door assembly of claim 1 further comprising a graphic indicia having an edge, a first major face and a second major face, said graphic indicia located in said display cell and supported along said edge by said support channel, along said first major face by said first panel and along said second major face by said second panel.

17. The door assembly of claim 1 wherein said second panel has a reinforcing element formed along an edge of said second panel.

18. The door assembly of claim 1 wherein said second panel has an outwardly turned edge providing a grasping surface.

19. The door assembly of claim 18 wherein said reinforcement element comprises a bar formed along said outwardly turned edge.

20. A display device including the door assembly of claim 1 and further comprising an enclosure hingedly coupled to said door assembly and a light source disposed within said enclosure to provide back lit illumination of said second panel.
